(19) United States
(12) Patent Application Publication
(10) Pub. No.: US 2016/0322629 A1
(43) Pub. Date: Nov. 3, 2016

(54) HYBRID CATHODES FOR LI-ION BATTERY CELLS

(71) Applicant: Brookhaven Science Associates, LLC, Upton, NY (US)

(72) Inventors: Hong Gan, Miller Place, NY (US); Ke Sun, Middle Island, NY (US)

(21) Appl. No.: 15/138,470

(22) Filed: Apr. 26, 2016

Related U.S. Application Data
(60) Provisional application No. 62/155,251, filed on Apr. 30, 2015.

(51) Int. Cl. H01M 4/36; H01M 4/58; H01M 4/485; H01M 10/0525

(52) U.S. Cl. CPC H01M 4/364; H01M 10/0525; H01M 4/5815; H01M 4/485; H01M 4/5825; H01M 2004/028

(57) ABSTRACT

This disclosure describes the reduction or elimination of non-active carbon additive by introducing an electronic conductive secondary cathode component in a hybrid composite cathode.

### CROSS-REFERENCE TO A RELATED APPLICATION

This application claims the benefit under 35 U.S.C. 119(e) of U.S. Provisional Application No. 62/155,251 filed on Apr. 30, 2015, the content of which is incorporated herein in its entirety.

### STATEMENT OF GOVERNMENT RIGHTS

This invention was made with Government support under contract number DE-SC0012704 awarded by the U.S. Department of Energy. The Government has certain rights in the invention.

### FIELD OF THE INVENTION

This disclosure relates generally to battery cell systems. In particular, it relates to lithium-ion battery cell systems.

### BACKGROUND

Lithium ion batteries are used as power sources for consumer electronics, including laptops, tablets, and smart phones. The amount of energy stored by weight and/or volume is one way to measure performance in these applications. For larger applications, such as for example electric vehicles, power density may be measured. The batteries should be able to charge and discharge quickly as they react to sudden changes in load during actual driving conditions.

However, the cost of using lithium ion batteries in electric vehicles is high. Even for next generation Li-ion technologies under development, the predicted performance and cost metrics may still be unfavorable. In the past two decades, the chemistries of the lithium ion technologies have been intensively studied and the active material utilization is close to the theoretical limit. The graphite anode in conventional Li-ion batteries has already reached its theoretical capacity (372 mAh/g) with little room for improvement. The same limitation also applies to the layered transition metal oxides intercalation cathodes (˜250-300 mAh/g). While much effort have been devoted to the discovery of the new high energy density materials in recent years, such as alloy type of anodes (e.g. Si or Sn) and Sulfur cathode, as well as multivalent conversion reaction cathodes, the cell systems utilizing these new materials may not perform satisfactorily, especially in terms of cycle life, long term stability and reliability. Therefore the most practical system in the near future is still Li-ion chemistries based on intercalation active materials. Since approximately only 50% of the cell volume is occupied by the active materials, optimizing battery energy density (kWh/kg or kWh/L) and reducing cost ($/kWh) of the existing system is possible by removing or eliminating the non-active materials.

### SUMMARY

This disclosure is geared toward the reduction/elimination of non-active carbon additive by introducing an electronic conductive secondary cathode component in a hybrid composite cathode.

This disclosure provides embodiments of a battery cell system comprising which includes an anode current collector; an anode; an electrolyte; a cathode, the cathode comprising a lithium intercalation cathode and a transition metal sulfide; a separator between the cathode and the anode; and a cathode current collector.

Another embodiment provides a battery cell system which includes: an anode current collector; a lithium metal anode; an electrolyte; a cathode comprising a metal oxide and a transition metal sulfide; and a separator between the cathode and the lithium anode.

### BRIEF DESCRIPTION OF THE DRAWINGS

FIG. 1 is a graph showing the electronic conductivity of various cathode compounds.

FIG. 2 schematically demonstrates the concept cell reactions in an embodiment of a LiFePO₄/TiS₂ hybrid cathode coin cell.

FIG. 3A schematically illustrates an embodiment of a hybrid cathode cell.

FIG. 3B schematically illustrates another embodiment of a hybrid cathode cell.

FIG. 4 is a graph of the Cell Charge/Discharge Voltages vs. Capacity in an embodiment of a LiFePO₄/TiS₂ hybrid cathode cell.

FIG. 5 is a graph of the Cell cycling Voltage vs. Time in an embodiment of LiFePO₄/TiS₂ hybrid cathode cell.

### DETAILED DESCRIPTION

This disclosure provides embodiments of battery cells with a higher level of active materials than found in conventional lithium ion battery cells by reducing or eliminating the non-active carbon additives in the cell. Embodiments include introducing an electronic conductive secondary cathode component in a hybrid composite cathode.

The hybrid cathodes embodiments may enable versatile and tailor-made properties with electrochemical performances beyond those of the individual cathode. However, consideration should be made to prevent the potential detrimental interactions between the chosen materials. For example, for conductive carbon replacement in the cathode, the criteria for the choice of secondary cathode additives are:
Electronic conductive to take over the function of the replaced carbon material
Electrochemically active to provide extra cell energy density
Reversible redox reaction for extended cycle life
Chemically compatible with the other cell components for system stability
Low and acceptable material and process cost for practical large scale manufacturing

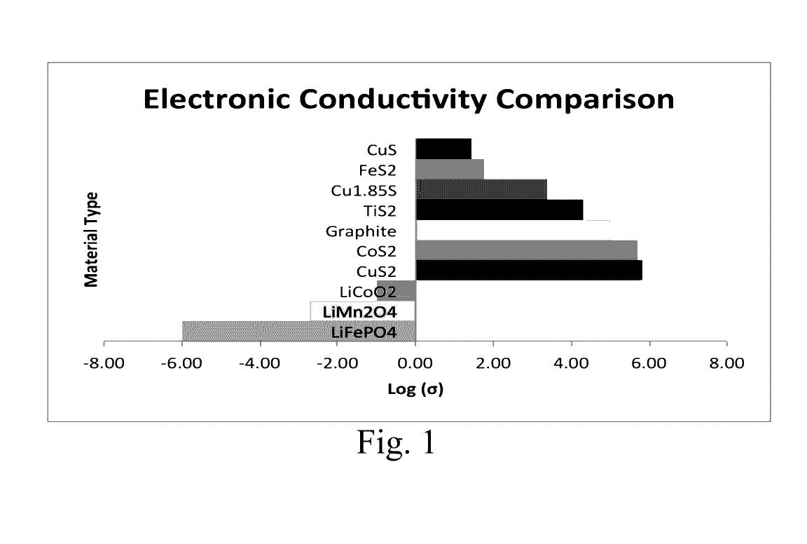

Transition metal sulfide materials meet these criteria. Some of them have already been used as cathode in the commercial high power thermal batteries and have been demonstrated to be rechargeable at ambient temperature in non-aqueous organic electrolyte lithium cells. In addition, many of the transition metal sulfides are highly conductive and some of them are even more conductive than graphite (FIG. 1). In comparison, the electronic conductivities of LiCoO₂, LiFePO₄ and LiMn₂O₄ are several orders of magnitude lower than those transition metal sulfides (FIG. 1). Therefore, the presence of transition metal sulfides as secondary cathode additive may enable the reduction or even elimination of the carbon additive within the cathode metrics. Furthermore, the selected transition metal sulfides/Li couples also have their theoretical energy densities (Wh/kg or Wh/L) comparable or higher than the traditional intercalation cathode/graphite (or Li metal) couple systems. Therefore, without changing the volume or weight ratio of the first cathode in the composite, any carbon additive replacement by transition metal sulfide will represent a net gain of cell energy density. By replacing carbon with a transition metal sulfide, the same existing equipment and electrode process conditions can be utilized without the need of new equipment and process investment.

The sulfide cathode additive may be a pre-lithiated metal sulfide when non-lithium containing anodes are used, such as graphite or silicon-carbon composite, or a non-lithiated metal sulfide if the anode is pre-lithiated, such as lithium metal or pre-lithiated graphite or Silicon.

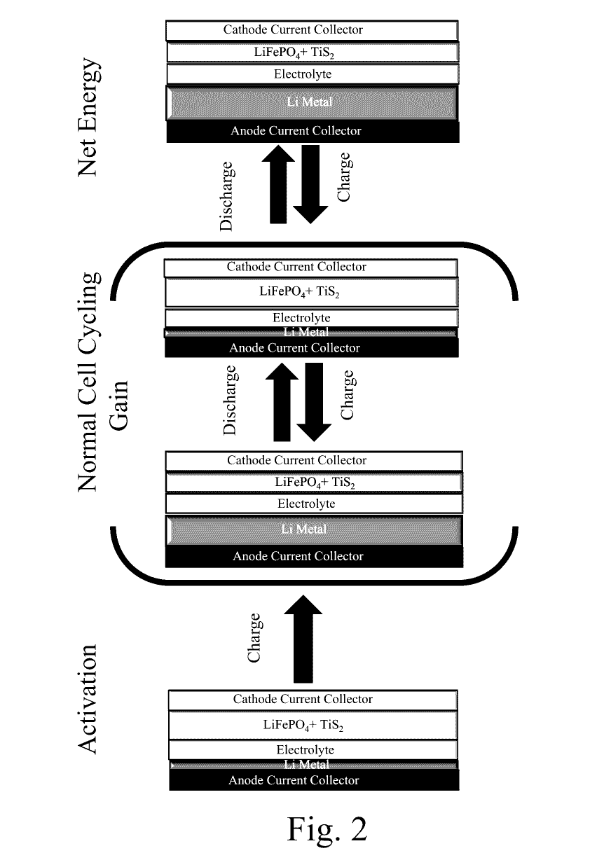

A sulfide cathode has average operation potentials ranging from 1.5V to 2.2V, which is lower than the first cathode (typical between 3.0V to 4.5V), such as LiCoO₂, LiFePO₄, LiMn₂O₄, LiNi_{1/3}Mn_{1/3}Co_{1/3}O₂, and metal oxides. Therefore, for hybrid cathode, the cathode materials can be selectively delithiated or lithiated by just controlling the cut off voltages. FIG. 2 demonstrates how an embodiment of a hybrid cathode (LiFePO₄+TiS₂ in this example for illustrative purposes) is cycled. During the charge activation, the LiFePO₄ will be delithiated and the cell will reach 100% SOC (FePO₄). At this point, the secondary cathode, TiS₂, will only act as conductive additive to enhance the electronic conductivity within the cathode metrics. During discharge, the FePO₄ cathode may be discharged to be fully lithiated at ˜2.5V voltage cut off. If the cell discharge stopped here, then the cathode may behave like a conventional LiFePO₄ cathode and the TiS₂ cathode may behave as a conductive additive. However, if more energy is required, the cathode can be further discharged to lower voltage, such as 1.5V, to get TiS₂ lithiated. The obtained cell capacity at this stage will be the net gain of the energy density at the cell level. Due to the high theoretical energy density of metal sulfide materials, this net energy density gain could be as high as 20% assuming 10 wt % of carbon is replaced by 10 wt % of the metal sulfide (example FeS₂ or CoS₂) in the cathode formulation. The gain could be even higher with volumetric energy density. Both first and second cathode reactions are reversible. Thus, at the end of discharge, the cathode can be recharged back to its full capacity by converting LiTiS₂ into TiS₂ and then charge the LiFePO₄ cathode to FePO₄.

Due to the difference in electrochemical potentials of the first vs. second cathodes, one can use the voltage cut off between the end of the first cathode discharge and beginning of the second cathode discharge as the end of life indicator, or fuel gauge, for practical electric vehicle application (for example 2.5V). The energy stored in the second cathode can be viewed as backup energy for emergency usage. The ratio between the two cathode materials can be adjusted for the desired reserve energy as part of the system design.

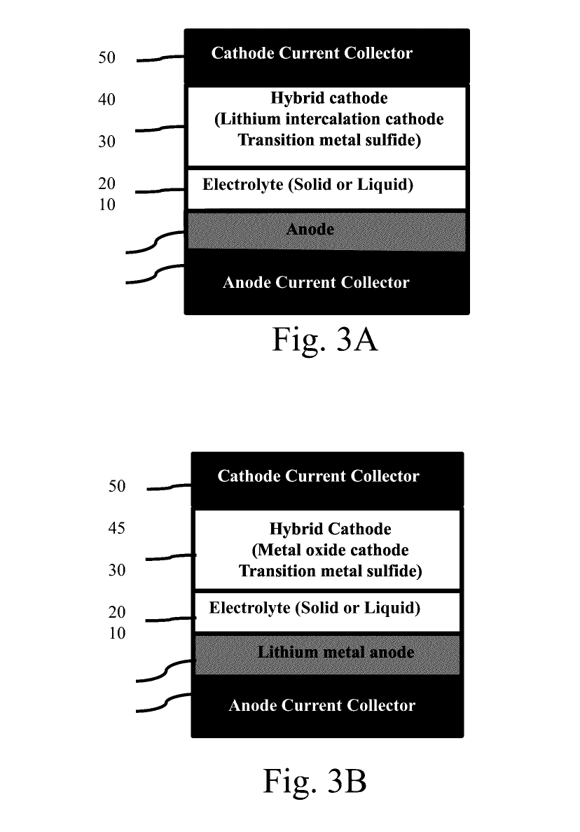

FIG. 3A schematically illustrates an embodiment of a hybrid cathode cell, and includes an anode current collector 10, an anode 20, an electrolyte 30, a hybrid cathode 40, and a cathode current collector 50.

The anode current collector 10 may comprise one or more of a variety of materials that can collect current from the anode, contact the anode without being reduced, and allow alkali ions from the anode to pass therethrough. Some non-limiting examples of suitable anode current collector materials include reduced, or pure, copper, nickel, stainless steel, brass (70% copper, 30% zinc), a suitable cermet material (e.g., a Cu/NaSICON, a Cu/LiSICON, etc.), and one or more other suitable materials.

The anode 20 may be for example silicon, graphite, carbon, graphene, combinations thereof, or any material known to be used for the anode. The carbon may be in the form of for example a nanotube. The anode when supplied with lithium thus may comprise lithium metal, lithiated graphite, or lithium-Si alloy.

The electrolyte 30 suitable in the present cell system may include any electrolyte know in the art. The electrolyte may comprise a liquid, a solid, or a polymer gel-type electrolyte. Specific examples may include but are not limited to a non-aqueous liquid or a solid polymer electrolyte that contains a dissolved lithium salt. In certain embodiments the electrolyte includes a lithium hexafluorophosphate solution in ethylene carbonate and dimethyl carbonate.

The hybrid cathode 40 may comprise a lithium intercalation cathode as the first cathode and a transition metal sulfide as the second cathode.

The lithium intercalation cathode may include any suitable intercalation cathode material known in the art, and may include at least one of lithiated transition metal oxides, lithiated transition metal phosphate, lithiated mixed transition metal oxides or phosphate, or combinations thereof. Examples include LiCoO₂, LiNi_{0.8}Co_{0.15}Al_{0.05}O₂, LiNi_{1/3}Mn_{1/3}Co_{1/3}O₂, LiMn₂O₄, LiFePO₄, and combinations thereof.

The transition metal sulfide may be in the form of a metal sulfide having the formulae MS, MS₂, Li₂₋ₓMS₂, or Li₂₋ₓMSₙ where 0<x<2, n is equal to or larger than 1. M is a transition metal. In certain embodiments, M is Co, Cu, Ni, Mn, Mo, Ti, Fe, or a combination thereof. In some embodiments, the second cathode is at least one of CoS₂, Cu₂S, CuS, CuS₂, TiS₂, FeS₂, FeS, Fe₁₋ₓS (where x is less than 1), NiS₂, MnS₂, MoS₂, Fe₇S₈, or a combination thereof.

The particle sizes of the hybrid cathode 40 materials may be in the range of nanometer to micrometer size. The smaller the particle size of the cathode additive, the easier or faster and more efficient the electrochemical reaction may be.

The weight ratio of the first cathode to the second cathode of the hybrid cathode 40may be between about 50:50 to about 99:1. Any ratio between about 50:50 and 99:1 is contemplated and disclosed herein. In one embodiment the ratio is about 81:19.

A separator such as for example a polyolefin separator may be incorporated with the cell system. The separator may be between the cathode and the anode. Other components of the lithium battery may include an external encapsulating shell, a cathode terminal, and an anode terminal.

FIG. 3B schematically illustrates an embodiment of a hybrid cathode cell, and, as in FIG. 3A, includes an anode current collector 10, anode 20, electrolyte 30, hybrid cathode 45, and a cathode current collector 50.

However, the first cathode of the hybrid cathode 45 may be a cathode which does not contain lithium ions to begin with. Lithium ions may be provided from lithium metal anode. The hybrid cathode 45 may comprise a metal oxide cathode as the first cathode and a transition metal sulfide as the second cathode. Suitable metal oxide cathodes include, but are not limited to, MnO₂, V₂O₅, copper vanadium oxide, silver vanadium oxide, copper-silver vanadium oxide, or a combination thereof. The transition metal sulfide may be in the form of a metal sulfide having the formulae MS, MS₂, Li₂₋ₓMS₂, or Li₂₋ₓMSₙ where 0<x<2, n is equal to or larger than 1. M is a transition metal. In certain embodiments, M is Co, Cu, Ni, Mn, Mo, Ti, Fe, or a combination thereof. In some embodiments, the second cathode is at least one of CoS₂, Cu₂S, CuS, CuS₂, TiS₂, FeS₂, FeS, Fe₁₋ₓS (where x is less than 1), NiS₂, MnS₂, MoS₂, Fe₇S₈, or a combination thereof

In another embodiment, a method of making the present lithium battery with a hybrid cathode is provided. The process may include: a) cathode preparation by using the conventional lithium-ion or other cathode preparation method, including coating a cathode mixture slurry on a current collector or pressing a cathode mixture onto the current collector, where the cathode mixture contains the hybrid cathode as well as any potential conductive additive (may be present in a lower amount than what would be used without the second cathode), and binder materials; b) preparation of the anode by processing/cutting the anode into the pre-determined shape and dimension; c) cell assembly by sandwiching separator material between the above prepared cathode and the anode in multiple designs, such as cylindrical wound cell, prismatic wound cell, single cell stack layer or multiple plates cell stack designs; d) placement of the cell assembly inside a cell enclosure (case, pouch, etc.); e) activating the cell with electrolyte injection (for liquid electrolyte cell design) and sealing the enclosure; f) activating the cell by charging the cell.

Additional components such as electrolytes, terminals, casings and other components known in the art can be combined with the lithium battery containing the hybrid cathode described herein to produce operable lithium batteries for powering electrical devices. The cell system may be in the form of a thin-film, thick-film or bulk battery. These systems may include high energy density batteries, secondary batteries or rechargeable batteries such as for example. It is desirable to use the present hybrid cathode in batteries for a variety of devices such as for example, complementary metal oxide semiconductor (CMOS) back-up power, microsensors, smart cards, radio frequency identification (RFID) devices, and micro-actuators. Other devices may include personal digital assistants, and portable electronics.

With the present hybrid cathode utilized in a lithium battery, a conductive second cathode boost the cathode electronic conductivity that may contribute to replacing the carbon additive, at least partially, for improved volumetric cathode energy density. Due to the conducting nature of the transition metal sulfide, the amount of filler (e.g., carbon black, carbon nanotubes, or graphene) generally used to improve cathode conductivity may be reduced, which may in turn improve the volumetric energy density of the cathode due to the density difference between the transition metal sulfide and other filler materials.

### EXAMPLE

### Experimental

All chemicals used in this example were used as they were received without further purification. To make the LiFePO₄—TiS₂ composite electrode, 0.8 g LiFePO₄ (A123), 0.05 g TiS₂ (Sigma Aldrich), 0.1 g Super C65 (TIMCAL) and 0.0 5g PVDF (5 wt % in NMP) were mixed thoroughly in a mortar and pestle to form a uniform mixture before 7 g of N-Methyl-2-pyrrolidone (NMP) was added to the mixture. The mixture was further homogenized until a uniform slurry was obtained. After a uniform slurry was obtained, the slurry was coated onto an aluminum foil with a doctor blade, and the coated sample was dried in air for 24 hours, followed by another 24 hours in a vacuum oven at 100° C. The dried sample was punched into small disks to be used as electrodes. CR2032 sized coin cells were assembled with small punched cathode, a lithium foil as counter electrode, polypropylene membrane as separator, and 1M LiPF₆/EC:DMC=1:1 v/v electrolyte. The cells were tested with an Arbin electrochemical station in Galvanostatic mode. The current density was chosen to be C/10 and the voltage range was set between 3.8 and 1.5V.

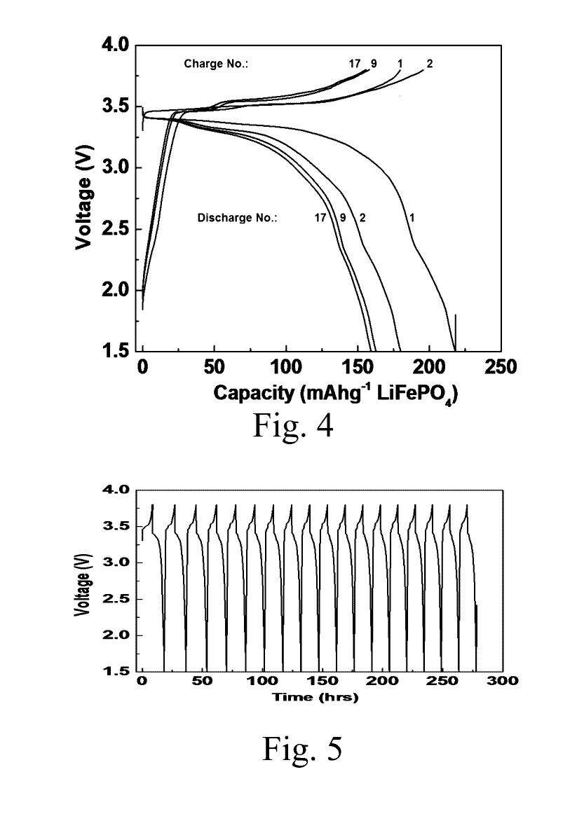

FIG. 4 is a graph of the Cell Charge/Discharge Voltages vs. Capacity of the LiFePO₄/TiS₂ hybrid cathode coin cell. FIG. 5 is a graph of the Cell cycling Voltage vs. Time showing the results of 18 cycles. FIG. 4 shows two voltage plateau regions for LiₓFePO₄ (˜3.4V) and TiS₂ (˜2.0V) discharges when the cell was cycled between 3.80V to 1.50V under C/10 rate. The 1^{st} cycle charge capacity (179 mAh/g based on LiFePO₄) is close to LiFePO₄ theoretical capacity (170 mAh/g). While the 1^{st} discharge resulted in 218 mAh/g that is significantly higher than the theoretical capacity of LiFePO₄. The extra capacity beyond the theoretical is contributed by TiS₂ additive. The 2^{nd} charge voltage profile shows TiS₂ portion of the voltages (1.5V to 2.5V) and the LiFePO₄ portion of the voltages (2.5V to 3.8V) with 196 mAh/g capacity achieved—higher than 1^{st} charge and LiFePO₄ theoretical capacity. This data also indicate that the lithiated TiS₂ (or LiTiS₂) can be delithiated during charge. Therefore, if the lithiated transition metal sulfide is used, the system can be paired with graphite or intermetallic alloy (such as Silicon, Sn, Ge, etc.) anode to achieve the same advantages as described above.

1. A battery cell system comprising:
an anode current collector;
an anode;
an electrolyte;
a cathode, the cathode comprising a lithium intercalation cathode and a transition metal sulfide;
a separator between the cathode and the anode; and
a cathode current collector.

2. The battery cell system of claim 1, wherein the anode comprises a lithium metal anode, a graphite anode, a silicon anode, a lithiated graphite (LiₓC₆, x<1), a lithiated silicon (LiₓSi, x<4.4), or a combination thereof.

3. The battery cell system of claim 1, wherein the lithium intercalation cathode comprises at least one of lithiated transition metal oxides, lithiated transition metal phosphate, or lithiated mixed transition metal oxides or phosphate, or combinations thereof.

4. The battery cell system of claim 1, wherein the lithium intercalation cathode comprises at least one of LiCoO₂, LiNi_{0.8}Co_{0.15}Al_{0.05}O₂, LiNi_{1/3}Mn_{1/3}Co_{1/3}O₂, LiMn₂O₄, or LiFePO₄.

5. The battery cell system of claim 1, wherein the transition metal sulfide is at least one of MS, MS₂, Li₂₋ₓMS₂, or Li₂₋ₓ MSₙ where 0<x<2, n is equal to or larger than 1, and M is a transition metal.

6. The battery cell system of claim 5 wherein the transition metal sulfide is at least one of CoS₂, Cu₂S, CuS, CuS₂, TiS₂, FeS₂, FeS, Fe₁₋ₓS (where x is less than 1), NiS₂, MnS₂, MoS₂, or Fe₇S₈.

7. The battery cell system of claim 1, the battery cell system having a first and a second voltage plateau regions.

8. The battery cell system of claim 7, wherein the first voltage plateau region is at above about 2.5 volts.

9. The battery cell system of claim 7, wherein the first voltage plateau region is at above about 3 volts.

10. The battery cell system of claim 8, wherein the second voltage plateau region is at between about 1.5 volts and about 2.5 volts.

11. A battery cell system comprising:
an anode current collector;
a lithium metal anode;
an electrolyte;
a cathode comprising a metal oxide and a transition metal sulfide; and
a separator between the cathode and the lithium anode.

12. The battery cell system of claim 11, wherein the transition metal sulfide is at least one of MS, MS₂, Li₂₋ₓMS₂, or Li₂₋ₓ MSₙ where 0<x<2, n is equal to or larger than 1, and M is a transition metal.

13. The battery cell system of claim 12, wherein M is Co, Cu, Ni, Mn, Mo, Ti, or Fe.

14. The battery cell system of claim 13 wherein the transition metal sulfide is at least one of CoS₂, Cu₂S, CuS, CuS₂, TiS₂, FeS₂, FeS, Fe₁₋ₓS (where x is less than 1), NiS₂, MnS₂, MoS₂, or Fe₇S₈.

15. The battery cell system of claim 11, wherein the metal oxide is at least one of MnO₂, V₂O₅, a copper vanadium oxide, a silver vanadium oxide, a copper-silver vanadium oxide, or a combination thereof.

16. The battery cell system of claim 11, the battery cell system having a first and a second voltage plateau regions.

17. The battery cell system of claim 16, wherein the first voltage plateau region is at above about 2.5 volts.

18. The battery cell system of claim 16, wherein the first voltage plateau region is at above about 3 volts.

19. The battery cell system of claim 17, wherein the second voltage plateau region is at between about 1.5 volts and about 2.5 volts.

20. A lithium battery comprising a hybrid cathode and a first operating voltage of above about 3 volts and a second operating voltage of above about 2 volts.
